(19) United States
(12) Patent Application Publication
(10) Pub. No.: US 2025/0290858 A1
(43) Pub. Date: Sep. 18, 2025

(54) RAPID SCREENING TEST FOR SKIN SENSITIZATION RISK ASSESSMENT

(71) Applicant: Raminder Saluja, Huntersville, NC (US)

(72) Inventor: Raminder Saluja, Huntersville, NC (US)

(21) Appl. No.: 19/076,301

(22) Filed: Mar. 11, 2025

Related U.S. Application Data
(60) Provisional application No. 63/564,102, filed on Mar. 12, 2024.

(51) Int. Cl. G01N 21/78; B01L 3/00; G01N 21/77

(52) U.S. Cl. CPC G01N 21/78; B01L 3/5023; B01L 2200/16; B01L 2300/069; G01N 2021/7759

(57) ABSTRACT

Embodiments of the instant invention relate to compositions and methods for identifying and assessing risk for topical substances on the skin for eliciting a Type IV hypersensitivity reaction via a chemical colorimetric screening in a rapid diagnostic assay. In some embodiments, the methods comprise colorimetric chemical change with subsequent identification of the ability to elicit an allergic response.

### CROSS-REFERENCE TO RELATED APPLICATION

This application claims the benefit of U.S. Provisional Application No. 63/564,102, filed Mar. 12, 2024, the entire disclosure of which is hereby incorporated herein by reference.

### TECHNICAL FIELD

Aspects of this disclosure generally are related to identifying and assessing risk for topical substances on the skin for eliciting a Type IV hypersensitivity reaction.

### BACKGROUND

Manufacturers of cosmetic products in the US submit allergy risk data to the US Food and Drug Administration (FDA) via Human Repeat Insult Patch Testing (HRIPT) as a standard protocol. HRIPT is an extensive process, enrolling multiple patients, evaluated over 6 weeks, to detect signs of Type IV Allergic Hypersensitivity.

HRIPT, however, is time consuming and resource intensive. Further, HRIPT may also raise ethical issues in that human subjects may be sensitized with subsequent skin tissue reaction as a testing endpoint. It is also known that HRIPT testing may not always provide accurate or sensitive results. False positives or negatives can occur, leading to unreliable data. Moreover, human skin reactions in HRIPT testing can be subjective, relying on visual assessments by trained observers. Subjects are e recruited for HRIPT; thus, recruitment, secondary to cost, may limit the number of recruited subjects, thereby hindering the diversity needed to evaluate skin sensitivity fully.

Alternative testing performed in the EU includes Direct Peptide Reactivity Assay (DPRA), which is a chemistry-based assay. Nucleophile-containing synthetic peptides such as cysteine and lysine are combined with a test substance. Depletion of the peptide, through covalent binding of the test substance with the synthetic peptide, is then detected and quantified via mass spectrometry or high-performance liquid chromatography. If depletion or a reduction of the peptide is detected, this can indicate possible allergenicity, and additional testing is recommended.

As just noted, however, DPRA utilizes high-performance liquid chromatography or mass spectrometry. Thus, each test may be expensive. Further, the equipment is expensive, and the technical staff needed to run the equipment also adds to the costs associated with DPRA.

Finally, there are practice considerations for diagnoses of allergies. Allergic contact dermatitis is one of the main issues that patients seek dermatological care.

Accordingly, a need exists for improved and/or more efficient testing when identifying and assessing risk for topical substances on the skin for eliciting a Type IV hypersensitivity reaction.

### SUMMARY

At least the above-discussed need is addressed and technical solutions are achieved in the art by various embodiments of the present invention.

In some embodiments, a kit for identifying and assessing risk for topical substances on the skin for eliciting a Type IV hypersensitivity reaction comprises a first container including a first synthetic peptide; a second container including a filter and a second synthetic peptide, the second container being configured to receive a substance to be tested with the filter being disposed between the substance to be tested and the second synthetic peptide; a first well and a first testing strip including a first conjugated reagent, the first testing strip including the first conjugated reagent being configured to change color in response to being exposed to the first synthetic peptide introduced from the first container via the first well; and a second well and a second testing strip including a second conjugated reagent, the second testing strip including the second conjugated reagent being configured to change color in response to being exposed to a mixture, of the second synthetic peptide and at least a portion of the substance to be tested having penetrated the filter, introduced from the second container via the second well.

In some embodiments, a kit for identifying and assessing risk for topical substances on the skin for eliciting a Type IV hypersensitivity reaction comprises a control configured to provide a predetermined color; a container including a filter and a synthetic peptide, the container being configured to receive a substance to be tested with the filter being disposed between the substance and the synthetic peptide; and a tester including a reagent and being configured to change color in response to being exposed to a mixture, of the synthetic peptide and at least a portion of the substance to be tested having penetrated the filter, received from the container.

In some embodiments, a method of identifying and assessing risk for topical substances on the skin for eliciting a Type IV hypersensitivity reaction comprises filtering a substance to be tested; introducing the filtered substance to a synthetic peptide to thereby obtain a mixture of the filtered substance and the synthetic peptide; and introducing the mixture of the filtered substance and the synthetic peptide to a reagent, wherein in a first case where the filtered substance does not covalently bind to the synthetic peptide, the reagent, having been introduced to the mixture of the filtered substance and the synthetic peptide, changes color to a predetermined color, and wherein in a second case where the filtered substance covalently binds to the synthetic peptide, the reagent, having been introduced to the mixture of the filtered substance and the synthetic peptide, does not change color or does not change color to the predetermined color.

In some embodiments, a diagnostic kit for identifying and assessing the risk of topical substances causing a Type IV hypersensitivity reaction on the skin comprises a colorimetric screening assay with a conjugated reagent pad configured to detect (i) an absence of covalent binding of a synthetic peptide with a chemical being tested by a first color change indicated on the conjugated reagent pad or (ii) a presence of covalent binding of the synthetic peptide with the chemical being tested by a lack of color change indicated on the conjugated reagent pad or by a second color change indicated on the conjugated reagent pad different from the first color change.

### BRIEF DESCRIPTION OF THE DRAWINGS

It is to be understood that the attached drawings are for purposes of illustrating aspects of various embodiments and may include elements that are not to scale. It is noted that like reference characters in different figures refer to the same objects.

FIG. 1 illustrates a diagnostic assay according to some embodiments of the present invention; and

FIG. 2 illustrates test tubes for use in testing according to some embodiments of the present invention.

### DETAILED DESCRIPTION

At least the above-discussed need is addressed, and technical solutions are achieved by various embodiments of the present invention. It should be noted that the invention is not limited to any embodiments provided herein, which are referred to for purposes of illustration only.

It should be noted that various embodiments of the invention are not limited to the features and benefits described herein, which are referred to for purposes of illustration only, and additional and alternative features and benefits will become apparent from the following description in conjunction with reference to the figures.

In this regard, in the descriptions herein, certain specific details are set forth in order to provide a thorough understanding of various embodiments of the invention. However, one skilled in the art will understand that the invention may be practiced at a more general level without one or more of these details. In other instances, well-known structures have not been shown or described in detail to avoid unnecessarily obscuring descriptions of various embodiments of the invention.

Any reference throughout this specification to “one embodiment”, “an embodiment”, “an example embodiment”, “an illustrated embodiment”, “a particular embodiment”, and the like means that a particular feature, structure or characteristic described in connection with the embodiment is included in at least one embodiment. Thus, any appearance of the phrase “in one embodiment”, “in an embodiment”, “in an example embodiment”, “in this illustrated embodiment”, “in this particular embodiment”, or the like in this specification is not necessarily all referring to one embodiment or a same embodiment. Furthermore, the particular features, structures or characteristics of different embodiments may be combined in any suitable manner to form one or more other embodiments. In one embodiment, all references to “some embodiments” may refer to the same single embodiment.

As can be understood from the above Background discussion, the ability to avoid expensive testing, such as HRIPT, would be very beneficial. Further, a need exists for a reliable, low-cost transportable solution, potentially for household testing uses, that may be simply and safely used.

Embodiments of the instant invention evaluate a synthetic peptide's ability to bind to a test substance utilizing a colorimetric strip as an indicator instead of conventional methods in existence (e.g., liquid chromatography and mass spectrometry). When the synthetic peptide covalently binds with a reagent, the interaction creates a vivid color change, which serves as a control. If a test substance is placed in contact with the synthetic peptide, in a case where covalent binding occurs, the covalent binding could be indicative of haptenation, which occurs in the skin. If this mixture is placed with the reagent, the reagent is less able to bind to the synthetic peptide (as the synthetic peptide has been covalently bound to the test substance). Therefore, the colorimetric change (indicating binding of the reagent to the synthetic peptide) would either not occur or would be less abundant than the control (e.g., a colorimetric change that is lighter than the control).

If the colorimetric change that is lighter than the control occurs, further testing (via HRIPT) may need to be undertaken. It is also possible that depending on the diagnosis, HRIPT testing may be avoided.

On the other hand, if the color change is equivalent to the control, then this is indicative of no haptenation or interaction of the test substance with the synthetic peptide, and no HRIPT would be indicated.

The cosmetic market has expanded significantly over the past decade, with new products being introduced daily. Although the responsibility for safety substantiation lies with the manufacturers, many consumers are eager to identify which products may be causing their contact dermatitis. Not only can embodiments of this invention be instrumental to efficiently dictate whether proceeding with HRIPT is necessary, they can also provide a simplistic testing method for preclinical and industrial chemical ingredients and for cosmetic products (incorporating personal care products, household products, agricultural products, or any other product that may come in contact with the skin) as well as for consumers in their home.

While the FDA mandates the manufacturer to ensure safety substantiation testing, it is possible that sufficient safety and efficacy testing allows the FDA or another regulatory body to only ask for this data if an adverse event occurs. The simplistic nature of the test, according to embodiments of the invention described herein, may allow regulatory bodies to have pre-adverse event data and “retail” consumers to use the steps in a kit at home. Some embodiments are therefore directed to knowledgeable or teachable, responsible retail consumers desiring to take more control of health decisions.

Since allergic contact dermatitis is one of the main issues that patients see a dermatologist for, a household-products test version would provide substantial critical information for better decision-making and safety.

An additional use of embodiments may arise where a double negative test, as explained below, is used to avoid the requirement of taking an HRIPT or similar diagnostic. Regulations or legislation, for example from the Modernization of Cosmetic Regulation Act signed into law in December of 2022, may require all cosmetic manufacturers to register and for mandatory Adverse Reaction Reporting. Cosmetic companies may be supported with basic safety data provided by embodiments of this invention.

Additional uses of embodiments of the invention include cosmetic, personal care, household cleaning, and dental care products that touch the skin or mucosal membrane. Embodiments may be beneficial for, for example, product testing, preclinical chemical testing, military chemical testing, at home testing, personalized allergy testing format, and FDA registration industry guidelines. Further, preclinical testing may use embodiments, not just for a completed “product,” but also chemicals in various preclinical testing stages, where pharmaceuticals must quickly and efficiently rule out as perspective allergens (synthetic chemical moieties). Embodiments may be applicable to civilians and military, for example, possibly used by military when encountering various chemicals.

In some embodiments, integration with a software application may be contemplated. For example, a mobile device application incorporating a form of spectrometry may be used by first using the device's camera to evaluate the intensity of the control and then via the camera hovering over the test and giving the degree of desaturation noted with correlative numerical data.

More specifically, according to some embodiments of the invention, methodologies are described below, where the test is done via a diagnostic colorimetric screening assay.

### [Control]

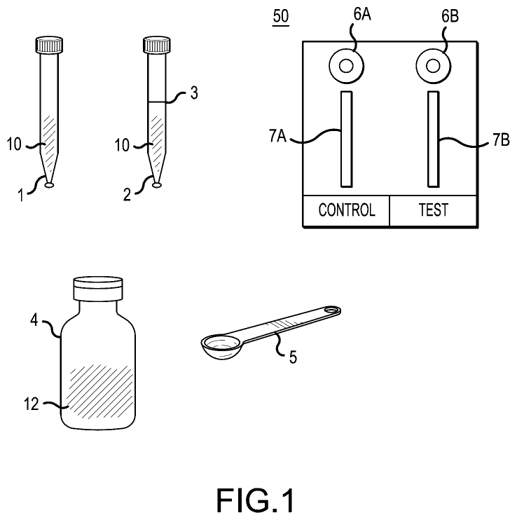

Referring to FIG. 1, in one embodiment, to obtain a control, a synthetic peptide 10 may be disposed in a test tube 1 having a dropper bottom. In an embodiment, the synthetic peptide 10 may be lysine. In another embodiment, the synthetic peptide 10 may be cysteine. Droplets from the test tube 1 may be placed into the well 6a of a diagnostic assay 50, which may be labeled as the “control.”

The assay 50 may further include testing papers 7A and 7B, which may be, for example, nitrocellulose paper, having an identified reagent conjugated or pre-absorbed into the micropores of the testing paper. In one embodiment, in a case where the synthetic peptide 10 is lysine, the reagent may be ninhydrin, and the testing papers 7A and 7B may be conjugated with ninhydrin. In another embodiment, in a case where the synthetic peptide 10 is cysteine, the reagent may be 5,5′-dithiobis-(2-nitrobenzoic acid) (i.e., Ellman's reagent), and the testing papers 7A and 7B may be conjugated with 5,5′-dithiobis-(2-nitrobenzoic acid) (i.e., Ellman's reagent). The synthetic peptide 10, having been placed into the well 6A of the diagnostic assay 50, covalently binds to the paper 7A including the conjugated reagent.

The reagent-absorbed testing paper 7A, via this covalent binding, creates a vivid colorimetric change, which serves as the control. In an embodiment, in a case where the synthetic peptide 10 is lysine, the reagent-absorbed testing paper 7A may change into a deep purple color. In another embodiment, in a case where the synthetic peptide 10 is cysteine, the reagent-absorbed testing paper 7A may change into a yellow color.

### [Assay 1—Testing a Liquid Topical]

In an embodiment, when the chemical being tested is a liquid, a second test tube 2, including the synthetic peptide 10 therein, will also be equipped with a filter 3 that represents the absorbance capacity of the stratum corneum based on chemical moiety size (less than 500 Dalton). In some embodiments, the filter 3 may be a synthetic or lipid-based membrane. The chemical to be tested is placed above the filter 3 so that it may, if possible, percolate through the filter 3. For example, if the chemical has large molecules, it will not penetrate the filter 3, similar to the skin.

With the second test tube 2, the test tube has the synthetic peptide 10 below the filter 3 so that any chemical that did percolate through mixes with the synthetic peptide 10.

This mixture is then allowed to sit and incubate. In an embodiment, the incubation time may be determined, based on, for example, a chemical concentration of the substance being tested, a chemical concentration of the synthetic peptide (e.g., 10:1 for lysine and 50:1 for cysteine), a chemical concentration of the reagent, and a temperature of the mixture including the filtered chemical and the synthetic peptide 10.

Once the incubation time has elapsed, droplets of the combined mixture may be placed into the well 6B on the test side. In an embodiment, the control may be on the left side and the test side may be on the right side.

It can be appreciated that if the chemical being tested covalently binds to the synthetic peptide 10, there will be less synthetic peptide that can bind to the conjugated nitrocellulose paper 7B. Thus, in this case, the colorimetric change will be less vivid than the control. This less vivid colorimetric change indicates a positive test, meaning there is a risk of allergenicity. Accordingly, with a positive test, further testing would recommended, such as HRIPT, as this covalent binding is representative of haptenation in the skin, which is the molecular initiating event for developing Type IV Hypersensitivity.

On the other hand, it can be appreciated that if the chemical being tested does not covalently bind to the synthetic peptide 10, synthetic peptide is available to bind to the conjugated or impregnated nitrocellulose paper 7B, like in the control. In this case, the colorimetric change may be equivalent to the control, thereby indicating that covalent binding did not occur. Therefore, HRIPT, which is performed as a preliminary test for the FDA, would not be needed.

### [Assay 2—Testing an Emulsion, Lotion, Solid]

In another embodiment, a non-liquid product may be tested. For example, an emulsion, lotion, or solid may be tested as non-liquid products. When testing a non-liquid product, the product should first be liquified. According to one embodiment, the non-liquid product may be liquified by obtaining a portion of the product using an aliquot measuring device 5 and then placing the portion of the product in a saline solution 12. The product may then be allowed to incubate for an appropriate period of time. The incubation time may be determined, based on, for example, a chemical concentration of the product being tested, a chemical concentration of the saline solution and amount used and a temperature of the mixture including the product being tested and the saline solution.

In some embodiments, the saline solution 12 may be provided in a bottle 4.

After the incubation period, the mixture of the product and saline solution may be added to a test tube 2 including the synthetic peptide 10 therein and a filter 3 that represents the absorbance capacity of the stratum corneum based on chemical moiety size (less than 500 Dalton). The mixture, having been placed in the test tube 2 above the filter 3, may percolate through the filter 3 and incubate for a period of time, to see if covalent binding occurs with the synthetic peptide. Once the incubation time has elapsed, droplets of the combined mixture may be placed into the well 6B on the test side. As described above, the incubation time may be determined, based on, for example, a chemical concentration of the substance being tested, a chemical concentration of the synthetic peptide (e.g., 10:1 for lysine and 50:1 for cysteine), a chemical concentration of the reagent, and a temperature of the mixture including the filtered chemical and the synthetic peptide.

It can be appreciated that if the product being tested covalently binds to the synthetic peptide, there will be less synthetic peptide that can bind to the impregnated (conjugated) nitrocellulose paper 7B. Thus, in this case, the colorimetric change will be less vivid than the control. This less vivid colorimetric change indicates a positive test, meaning there is a risk of allergenicity. Accordingly, with a positive test, further testing would recommended, such as HRIPT, as this covalent binding is representative of haptenation in the skin, which is the molecular initiating event for developing Type IV Hypersensitivity.

On the other hand, it can be appreciated that if the product being tested does not covalently bind to the synthetic peptide, synthetic peptide is available to bind to the impregnated (conjugated) nitrocellulose paper 7B, like in the control. In this case, the colorimetric change may be equivalent to the control, thereby indicating that covalent binding did not occur. Therefore, HRIPT, which is performed as a preliminary test for the FDA, would not be needed.

Regarding the timing of the tests, the timing is based on how quickly the substance interacts with the synthetic peptide. This will in turn depend on appropriate concentrations of the peptide, for example, 10:1 for lysine and 50:1 for cysteine. Multiple additional ranges are available for concentration of the peptide, as these examples are non-limiting. Additional considerations effecting timing include effects for temperature (e.g., normal room temperature) versus slight heating to speed the binding.

As noted above, HRIPT may be costly and time consuming. Embodiments of the invention may provide a simple and relatively inexpensive test that may be used to determine if HRIPT can be avoided. HRIPT may not be needed, if indeed the first molecular initiating event (that being haptenation), does not occur. Thus, in some embodiments, if there is a negative test, for example, determined by two tests (i.e., a double negative test, one with lysine and a reagent and the other by cysteine and a reagent) to increase sensitivity of the test, then HRIPT would not be recommended.

An example of testing of the results can be performed with two chromatography papers being dipped in ninhydrin and allowing the two papers to dry (e.g., reagent conjugation or impregnation). A synthetic peptide (e.g., lysine) can be dripped from a test tube on one of the papers, turning it, for example, into a vivid shade of purple. A synthetic peptide (e.g., lysine) with crushed poison ivy in it can be allowed to incubate for approximately 20 minutes, and the result can then be dripped from a test tube on the other ninhydrin impregnated paper. The results will be that no purple appears.

As described herein, embodiments of the invention may include a kit that may utilize a colorimetric change without the need for mass spectrometry or liquid chromatography. For example, embodiments may incorporate use of colorimetric reagents rather than detection of the covalent binding of the chemical to the peptide by analyzing the mass of the remaining peptide via mass spectrometry or via use of high-performance liquid chromatography. Embodiments may include use of a rapid colorimetric kit.

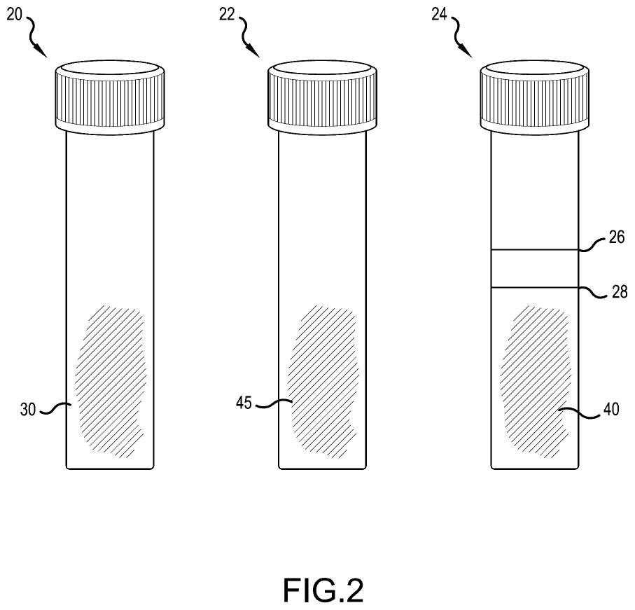

An alternative embodiment of the invention would not require a kit as disclosed above with reference to FIG. 1. Rather, in an alternative embodiment, referring to FIG. 2, a control could include a synthetic peptide plus reagent 30 in a test tube 20. The test would be performed using, if liquid, a test tube 24 with a filter 26 and synthetic peptide 40 at the bottom of tube 24. The liquid would percolate through the filter 26 and incubate. After the incubation period, the lower portion of tube 24 may be separated from the upper portion of tube 24, and the incubated material in the lower portion could then be placed into another test tube 22, which includes the reagent 45. In one embodiment, the lower portion of tube 24 may be separated from the upper portion of tube 24 by unscrewing the lower portion from the upper portion at threading 28. Both test tubes 20 and 22 could then be compared using, for example, a colorimeter that provides, for example, a numerical RGB (red green blue) level of saturation. The quantitative or comparative results from the control could correlate with the degree of saturation to give an indicator of mild, medium, high results.

Another alternative embodiment may incorporate a measure of non-liquid in testing by first liquefying, then placing the results in a tube 24 with a filter 26, allowing requisite time for percolation, incubation and, transfer of the incubated material to the tube 22 with the reagent 45, and evaluating the mixtures in tubes 20 and 22 with a camera (e.g., a mobile device camera) to first establish the control and then establish the test results based on the control.

In some embodiments of the invention, it is envisioned that the control may innately provide predetermined color information. For example, in some embodiments, the control may simply include a piece of paper (e.g., a small strip of paper) or any other material that can portray color, an image, or any other information that can adequately represent the deep purple color that occurs when lysine covalently bonds with ninhydrin or the pink color that occurs when cysteine covalently bonds with ninhydrin. When the control is provided in this manner, for example, the color of the impregnated nitrocellulose paper 7B, after the chemical being tested has been placed into well 6B, or the color of the mixture included in the test tube 22 prepared as described above, may be compared to the innate color of the control.

Embodiments may use test tubes comprised of plastic or acrylic, rather than glass, for shipping. Although test tubes are described herein, test tubes are not necessary to practice the invention. For example, any suitable container that can hold liquids and a filter may be used.

Reagents can be flammable, so they need to be packaged with proper care. Embodiments of the invention may be shipped or otherwise delivered to include a stand for the test tubes for placement while incubation occurs.

In some embodiment, a test kit may have a unique barcode or QR code and number, which may be scanned into an application prior to opening the test. It is envisioned in some embodiments that with the application, requisite basic information may be requested for use of the application, presenting a further means of controlling the data, which may include personally identifiable information requiring confidentiality controls for HIPAA and other regulatory regimes.

Additional benefits from receiving data at scale (e.g., via an application installed on a mobile device) include use of the data to quantitatively assess a risk of larger-scale or regional problems based on geolocated data, for health, agricultural, or other risks. For example, the FDA or another regulatory body may at times require safety substantiation data when there is an adverse event. Embodiments of the invention may allow for some safety-related data to be identified and provided to a government regulatory body prior to an adverse event. Embodiments of the invention, with sufficient detail, may be used to identify health concerns related to recreational parks, public swimming pools, lakes, or areas governed by municipalities or other regional activities, including large regions. Due to privacy and confidentiality controls, problems associated with monitoring health data at scale will be managed.

In some embodiments, percolated material from the test may be used for further testing with UV light to identify risk of, or presence of, any phototoxicity.

Additional embodiments or uses of the test kit may include a portable test for spaceflight, undersea, military (e.g., submarine), or outer space missions where allergy assessment of encountered materials may be needed.

As described herein, embodiments of the invention may provide numerous benefits. For example, a color-change endpoint based on covalent binding with a synthetic peptide may offer a more specific and sensitive measure of haptenation, potentially improving accuracy. A color-change endpoint may provide a more objective and quantifiable measure, reducing the potential for interpretation bias. HRIPT may not be needed if a negative test is noted via this rapid color test, thereby saving time and cost. The chemical interaction between the synthetic peptide and the test chemical can provide insights into the mechanistic aspect of haptenation.

A lack of color change on the colorimetric strip, caused by covalent binding between the synthetic peptide and test chemical, can indicate haptenation occurring on human skin, providing a more detailed understanding of a positive allergic responses. A color change noted on the colorimetric strip, would indicate no such covalent binding between the synthetic peptide and test chemical, indicating a low likelihood of an allergic response, subverting the need for additional costly HRIPT testing. The color-change method may contribute to the reduction of animal testing, which is in line with the FDA initiative of reducing, refining, and replacing animal testing.

Additional embodiments of the invention may include a kit for identifying and assessing risk for topical substances on the skin for eliciting a Type IV hypersensitivity reaction via a chemical colorimetric screening in a rapid diagnostic assay, comprising a conjugate pad colorimetric reactive test. The kit may also include a reagent impregnated on strips, where peptides are designed to covalently bind to the reagent on the strip. In some cases, multiple reagents may be utilized, which can create colorimetric results based on which synthetic peptide is used. In some cases, the assay may be configured to ascertain the risk of skin sensitization by demonstrating the initial molecular event for sensitization. The kit may also include a detection method via graded colorimetric change for given peptide and corresponding reagent.

Additional embodiments of the invention may include a conjugate pad colorimetric reactive test kit, including a reagent impregnated on each strip, where peptides are designed to covalently bind to the reagent on the strip, and where the kit is configured to ascertain the risk of skin sensitization by demonstrating the initial molecular event for sensitization.

Additional embodiments of the invention may include a colorimetric reactive test kit for identifying the need for further testing, comprised of 2 test kits with different synthetic peptides and corresponding reagents for creating colorimetric results based on which synthetic peptide used, where the kit is configured to ascertain the risk of skin sensitization by demonstrating the initial molecular event for sensitization, where the detection method occurs via graded colorimetric change for given peptide and corresponding reagent.

Additional embodiments of the invention may include a diagnostic colorimetric screening assay including a control assay and a test liquid topical assay, where the control assay is comprised of a synthetic peptide solution fluid in a test tube with a dropper bottom, where droplets are placed in the well of a diagnostic assay that is marked control, where nitrocellulose paper, impregnated (conjugated) with the identified reagent, reacts with the synthetic peptide solution, which covalently binds to the paper, and the reagent-impregnated nitrocellulose paper, via covalent binding, creates a vivid colorimetric change which serves as a control, where the test liquid topical assay is disposed in a second test tube with the synthetic peptide, where the test liquid topical assay is equipped with a filter that represents the absorbance capacity of the stratum corneum based on chemical moiety size. The chemical to be tested is placed above the filter so that it may percolate through, where below the filter, the test tube has the synthetic peptide solution so that any chemical that did percolate through mixes with the synthetic peptide, where the mixture sits for a predetermined incubation time, once the time has elapsed, the combined mixture (tiny droplets) is placed in the well on the test side (right side), and the test is performed to test the binding to the synthetic amino acid, where there will be less synthetic peptide that binds to the impregnated nitrocellulose paper so that the colorimetric change will be less vivid, assessing a risk of allergenicity compared to the control.

According to another embodiment, where the assay test is of an emulsion, lotion, or solid, which should first be liquified, the non-liquid product is placed via a given aliquot measuring device and allowed to sit for the stated amount of time, the mixture is placed in a test tube with a filter, the mixture percolates through and will incubate for a defined period of time to see if covalent binding occurs with the synthetic peptide, the dropper at the bottom of the tube will be uncapped, and droplets will be placed into the well designated as Test, a user determines whether a color change matches the control so follow on testing is not required, or a color change occurs that is attenuated compared to the control, indicating covalent binding of the chemical to the synthetic peptide, and therefore, less free peptide can bind to the reagent-impregnated nitrocellulose paper, indicting a likely need for follow-on testing.

Subsets or combinations of various embodiments described above provide further embodiments. These and other changes can be made to the invention in light of the above detailed description and still fall within the scope of the present invention. In general, in the following claims, the terms used should not be construed to limit the invention to the specific embodiments disclosed in the specification. Accordingly, the invention is not limited by the disclosure, but instead its scope is to be determined entirely by the claims.

What is claimed is:

1. A kit for identifying and assessing risk for topical substances on the skin for eliciting a Type IV hypersensitivity reaction, comprising:
a first container including a first synthetic peptide;
a second container including a filter and a second synthetic peptide, the second container being configured to receive a substance to be tested with the filter being disposed between the substance to be tested and the second synthetic peptide;
a first well and a first testing strip including a first conjugated reagent, the first testing strip including the first conjugated reagent being configured to change color in response to being exposed to the first synthetic peptide introduced from the first container via the first well; and
a second well and a second testing strip including a second conjugated reagent, the second testing strip including the second conjugated reagent being configured to change color in response to being exposed to a mixture, of the second synthetic peptide and at least a portion of the substance to be tested having penetrated the filter, introduced from the second container via the second well.

2. The kit of claim 1, wherein the first testing strip including the first conjugated reagent is configured to change color to a first color in response to being exposed to the first synthetic peptide, and
wherein the second testing strip including the second conjugated reagent is configured to change color to the first color in response to being exposed to the mixture of the second synthetic peptide and the at least the portion of the substance to be tested having penetrated the filter in a first case where the at least the portion of the substance to be tested does not covalently bind to the second synthetic peptide.

3. The kit of claim 2, wherein the second testing strip including the second conjugated reagent is configured to not change color, or to have a less vivid color change than a color change of the first testing strip including the first conjugated reagent, in response to being exposed to the mixture of the second synthetic peptide and the at least the portion of the substance to be tested having penetrated the filter in a second case where the at least the portion of the substance covalently binds to the second synthetic peptide.

4. The kit of claim 1, further comprising:
a measuring device configured to obtain a portion of a non-liquid substance to be tested; and
a saline solution configured liquify the obtained portion of the non-liquid substance to be tested.

5. The kit of claim 1, wherein the first container is a test tube having a dropper bottom, and the second container is a test tube having a dropper bottom.

6. The kit of claim 1, wherein the first reagent is ninhydrin, and the second reagent is ninhydrin.

7. The kit of claim 6, wherein the first testing strip is nitrocellulose paper conjugated with ninhydrin, and the second testing strip is nitrocellulose paper conjugated with ninhydrin.

8. The kit of claim 7, wherein the first synthetic peptide is lysine, and the second synthetic peptide is lysine.

9. The kit of claim 1, wherein the first synthetic peptide is cysteine, and the second synthetic peptide is cysteine, and
wherein the first testing strip is nitrocellulose paper conjugated with 5,5′-dithiobis-(2-nitrobenzoic acid), and the second testing strip is nitrocellulose paper conjugated with 5,5′-dithiobis-(2-nitrobenzoic acid).

10. The kit of claim 1, wherein the filter represents the absorbance capacity of the stratum corneum based on chemical moiety size.

11. A kit for identifying and assessing risk for topical substances on the skin for eliciting a Type IV hypersensitivity reaction, comprising:
a control configured to provide a predetermined color;
a container including a filter and a synthetic peptide, the container being configured to receive a substance to be tested with the filter being disposed between the substance to be tested and the synthetic peptide; and
a tester including a reagent and being configured to change color in response to being exposed to a mixture, of the synthetic peptide and at least a portion of the substance to be tested having penetrated the filter, received from the container.

12. The kit of claim 11, wherein the tester including the reagent is configured to change color to the predetermined color of the control in response to being exposed to the mixture of the synthetic peptide and the at least the portion of the substance to be tested having penetrated the filter in a first case where the at least the portion of the substance to be tested does not covalently bind to the synthetic peptide.

13. The kit of claim 12, wherein the tester including the reagent is configured to not change color, or to not change color to the predetermined color of the control, in response to being exposed to the mixture of the synthetic peptide and the at least the portion of the substance to be tested having penetrated the filter in a second case where the at least the portion of the substance to be tested covalently binds to the synthetic peptide.

14. The kit of claim 11, wherein the tester includes another container including the reagent.

15. The kit of claim 11, wherein the tester includes nitrocellulose paper conjugated with the reagent.

16. The kit of claim 11, wherein the control includes another container containing the synthetic peptide and the reagent.

17. The kit of claim 11, wherein the control includes nitrocellulose paper conjugated with the reagent.

18. The kit of claim 11, wherein the control innately provides the predetermined color.

19. A method of identifying and assessing risk for topical substances on the skin for eliciting a Type IV hypersensitivity reaction, comprising:
filtering a substance to be tested;
introducing the filtered substance to a synthetic peptide to thereby obtain a mixture of the filtered substance and the synthetic peptide; and
introducing the mixture of the filtered substance and the synthetic peptide to a reagent,
wherein in a first case where the filtered substance does not covalently bind to the synthetic peptide, the reagent, having been introduced to the mixture of the filtered substance and the synthetic peptide, changes color to a predetermined color, and
wherein in a second case where the filtered substance covalently binds to the synthetic peptide, the reagent, having been introduced to the mixture of the filtered substance and the synthetic peptide, does not change color or does not change color to the predetermined color.

20. A diagnostic kit for identifying and assessing the risk of topical substances causing a Type IV hypersensitivity reaction on the skin, the kit comprising:
a colorimetric screening assay with a conjugated reagent pad configured to detect (i) an absence of covalent binding of a synthetic peptide with a chemical being tested by a first color change indicated on the conjugated reagent pad or (ii) a presence of covalent binding of the synthetic peptide with the chemical being tested by a lack of color change indicated on the conjugated reagent pad or by a second color change indicated on the conjugated reagent pad different from the first color change.
